(19) United States
(12) Patent Application Publication
(10) Pub. No.: US 2008/0211750 A1
(43) Pub. Date: Sep. 4, 2008

(54) Resistance balance circuit

(75) Inventors: Tien-Fu Huang, Hsinchu (TW); Kuo-Chang Hu, Hsinchu (TW); Shih-Hao Hua, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/976,561

(22) Filed: Oct. 25, 2007

(30) Foreign Application Priority Data
Mar. 3, 2007 (TW) 096107331

(51) Int. Cl. G09G 3/32

(52) U.S. Cl. 345/82

(57) ABSTRACT

This invention discloses a resistance balance circuit including: at least two electronic components aligned in a row matrix, connected to one another in parallel, thereby forming a row matrix structure; an input end disposed at one end of the row matrix structure and configured for entry of current passing the electronic components in the row matrix structure; and an output end disposed diagonally opposite to the input end in the row matrix structure and configured for exit of the current passing the electronic components in the row matrix structure, wherein routes for the current passing the electronic components from the input end to the output end are equal in length, and thus the same current passes the electronic components in the matrix structure.

### BACKGROUND OF THE INVENTION

1. Field of the Invention

The present invention relates to resistance balance circuits, and more particularly, to a resistance balance circuit aligned in a column matrix or a row matrix and configured for electrical connection between at least two electronic components with a view to achieving homogeneity of current passing the electronic components.

2. Description of the Prior Art

Owing to their advantages over conventional light sources, namely being highly efficient, long-lived and durable, light emitting diodes (LEDs) are widely used in light source facilities, such as traffic signal lamps, vehicle lamps, desk lamps, street lamps, billboards, and liquid crystal display backlight modules.

The LED-based light source facilities require use of plenty LEDs, resulting in a LED array structure 1 shown in FIG. 1. Characteristics are different from LED to LED, so are routes provided for current to pass LEDs in the LED array structure, thus tilting resistance balance in the LED array structure. As a result, current flowing through the LEDs in the LED array structure differ from LED to LED, and thus the luminance levels of the LEDs are different from each other. Moreover, the effect of circuit resistance on current homogeneity of the LED array structure increases with the area of the LED array structure.

U.S. Pat. No. 5,598,068 was put forth in an attempt to solve the problem facing the LED array structure, that is, low homogeneity of luminance of light source facilities due to tilted resistance balance in the LED array structure. Referring to FIG. 2, U.S. Pat. No. 5,598,068 disclosed a current mirror 10 configured to provide constant current for each circuit 13 having a plurality of series-connected LEDs, wherein each circuit 13 having a plurality of series-connected LEDs is driven by a single constant current source 12 so as to homogenize the luminance provided by the light source facilities. Although the known problem of tilted resistance balance in the LED array structure can be solved with U.S. Pat. No. 5,598,068, high costs are incurred for driving each circuit 13 having a plurality of series-connected LEDs by means of a single constant current source 12. Moreover, semiconductor technology-based fabrication of light source facilities equipped with the LED array structure requires the current mirror 10 and constant current source 12 and thereby involves a complicated process.

Referring to FIG. 3A, U.S. Patent Application No. 2006/0171135 disclosed forming a LED package 14 with a plurality of parallel-connected LEDs 140, wherein forward biases of the LEDs 140 of the LED package 14 are properly set with a view to achieving homogeneity of current passing the parallel-connected LEDs 140 of each circuit and implement a LED array 15 having a plurality of the LED package 14 series-connected as shown in FIG. 3B. However, to enable homogeneity of the passing current, the parallel-connected LEDs 140 of the LED package 14 are aligned adjacent to one another to the detriment of heat dissipation, not to mention that the parallel connection of the LEDs 140 is unfavorable to RGB color mixing. Likewise, the LED array 15 having the series-connected LED packages 14 shares the same drawback, that is, circuit resistance unbalance, with the LED array structure shown in FIG. 1.

Accordingly, issues involving LED array-based light source facilities and calling for urgent solution are, namely improvement in LED array luminance homogeneity which has thus far remained unsatisfactory due to circuit resistance unbalance of the LED array, reduction of costs, and process streamlining.

### SUMMARY OF THE INVENTION

In light of the aforesaid drawbacks of the prior art, it is a primary objective of the present invention to disclose a resistance balance circuit, wherein at least two electronic components aligned in a column matrix or a row matrix are electrically connected to one another, so as to achieve resistance balance of routes for current passing the electronic components in the matrix structure, with a view to achieving homogeneity of current passing the electronic components and allowing the fabrication process to be cheaper and simpler.

In order to achieve the above and other objectives, the present invention discloses a resistance balance circuit, comprising: at least two electronic components aligned in a row matrix, connected to one another in parallel, thereby forming a row matrix structure; an input end disposed at one end of the row matrix structure and configured for entry of current passing the electronic components in the row matrix structure; and an output end disposed diagonally opposite to the output end in the row matrix structure and configured for exit of the current passing the electronic components in the row matrix structure, wherein routes for the current passing the electronic components from the input end to the output end are equal in length.

The resistance balance circuit comprises a plurality of row matrix structures. The output end and input end of the row matrix structures of one level are electrically connected to the input end of the row matrix structures of the lower level and the output end of the row matrix structures of the upper level respectively. The routes for the current passing the electronic components in the row matrix structures of all levels from the input end to the output end of the row matrix structures of all levels are equal in length.

The electronic components of the resistance balance circuit are preferably light emitting diodes.

In another preferred embodiment of the resistance balance circuit of the present invention, the resistance balance circuit comprises: a first level column matrix structure comprising at least two electronic components connected to one another in series; a second level column matrix structure comprising at least two electronic components connected to one another in series, wherein the second level column matrix structure is connected to the first level column matrix structure in parallel, and the first level column matrix structure comprises as many series-connected electronic components as the second level column matrix structure, thereby forming a multi-level column matrix structure; an input end disposed at one end of the multi-level column matrix structure and configured for entry of current passing the electronic components in the multi-level column matrix structure; and an output end disposed diagonally opposite to the output end in the multi-level column matrix structure and configured for exit of the current passing the electronic components in the multi-level column matrix structure, wherein routes for the current passing the electronic components from the input end to the output end are equal in length.

As regards the resistance balance circuit, at least one third level column matrix structure is parallel-connected to between the first level column matrix structure and the second level column matrix structure and provided with at least two series-connected electronic components, and the routes for the current passing the electronic components in the column matrix structures of all levels from the input end to the output end are equal in length.

The electronic components of the resistance balance circuit are preferably light emitting diodes.

A resistance balance circuit of the present invention enhances homogeneity of current passing electronic components, wherein at least two electronic components aligned in a column matrix or a row matrix are electrically connected to one another. The input end for entry of current passing the electronic components in the matrix and the output end for exit of current passing the electronic components in the matrix are disposed at opposite corners of the matrix. The routes for the current passing the electronic components from the input end to the output end are equal in length, such that the same current passes the electronic components in the matrix. The prior art is faced with a problem, that is, lack of homogeneity in luminance of an array of light emitting diodes due to circuit resistance. The resistance balance circuit of the present invention solves the problem by achieving resistance balance of routes for current passing the light emitting diodes

### BRIEF DESCRIPTION OF THE DRAWINGS

FIG. 1 (PRIOR ART) is a schematic view showing the circuit of a known light emitting diode array structure;

FIG. 2 (PRIOR ART) is a schematic view showing circuits each having a plurality of series-connected LEDs and provided with constant current by a current mirror in accordance with U.S. Pat. No. 5,598,068;

FIG. 3A (PRIOR ART) is a schematic view showing a LED package formed with a plurality of parallel-connected LEDs in accordance with U.S. Patent Application No. 2006/0171135;

FIG. 3B (PRIOR ART) is a schematic view showing a light emitting diode array formed with a plurality of series-connected LED packages shown in FIG. 3A;

FIG. 4A is a schematic view showing the first preferred embodiment of a resistance balance circuit of the present invention;

FIG. 4B is a schematic view showing the second preferred embodiment of a resistance balance circuit formed with a plurality of series-connected light emitting diode array structures shown in FIG. 4A;

FIG. 5A is a schematic view showing the third preferred embodiment of a resistance balance circuit of the present invention; and

FIG. 5B is a schematic view showing the fourth preferred embodiment of a resistance balance circuit formed with a plurality of parallel-connected light emitting diode array structures shown in FIG. 5A.

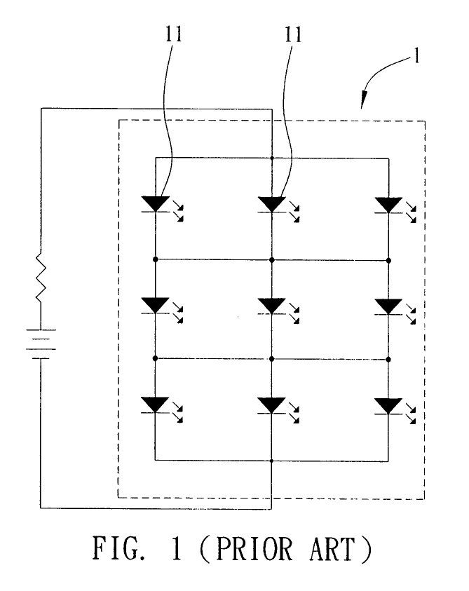

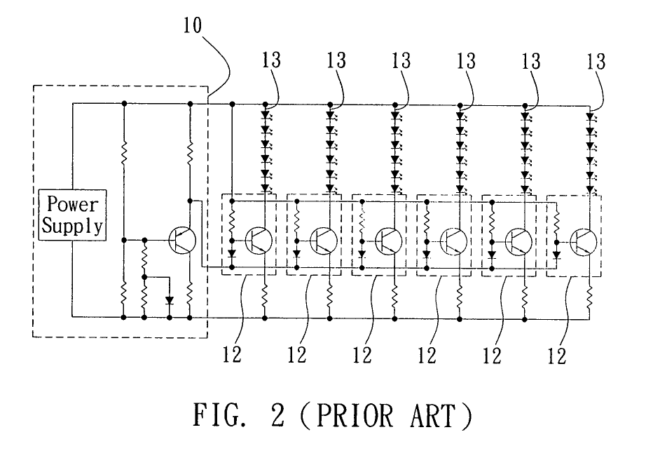

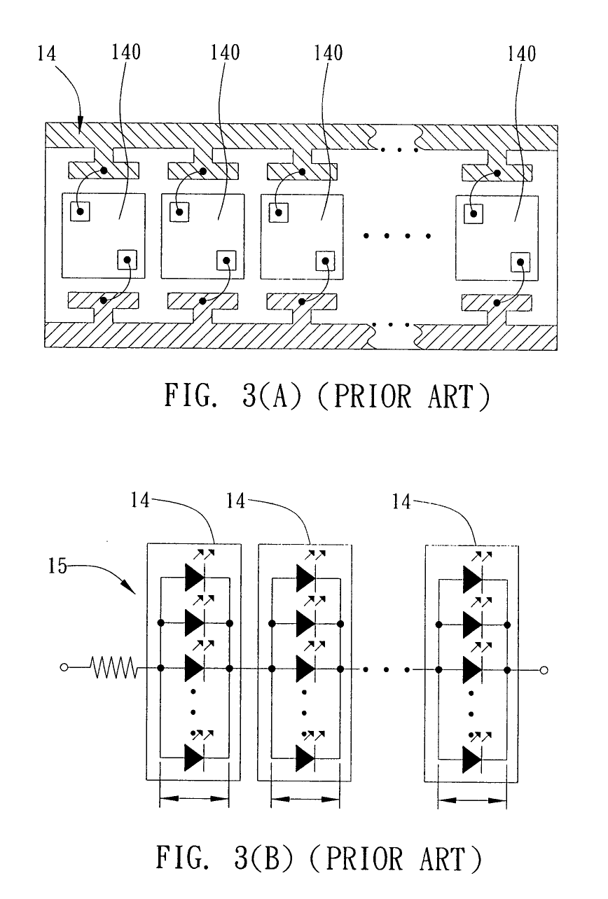

### DETAILED DESCRIPTION OF THE PREFERRED EMBODIMENTS

The following specific embodiments are provided to illustrate the present invention. Persons skilled in the art can readily gain insight into other advantages and features of the present invention based on the contents disclosed in this specification.

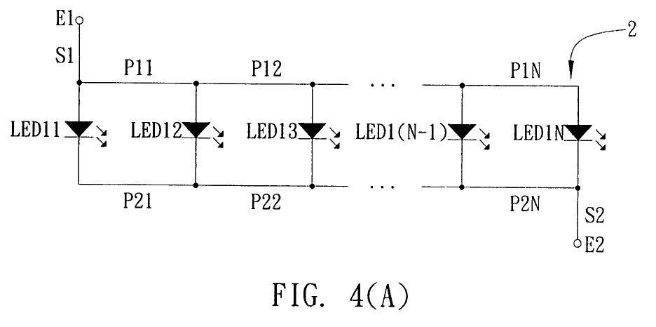

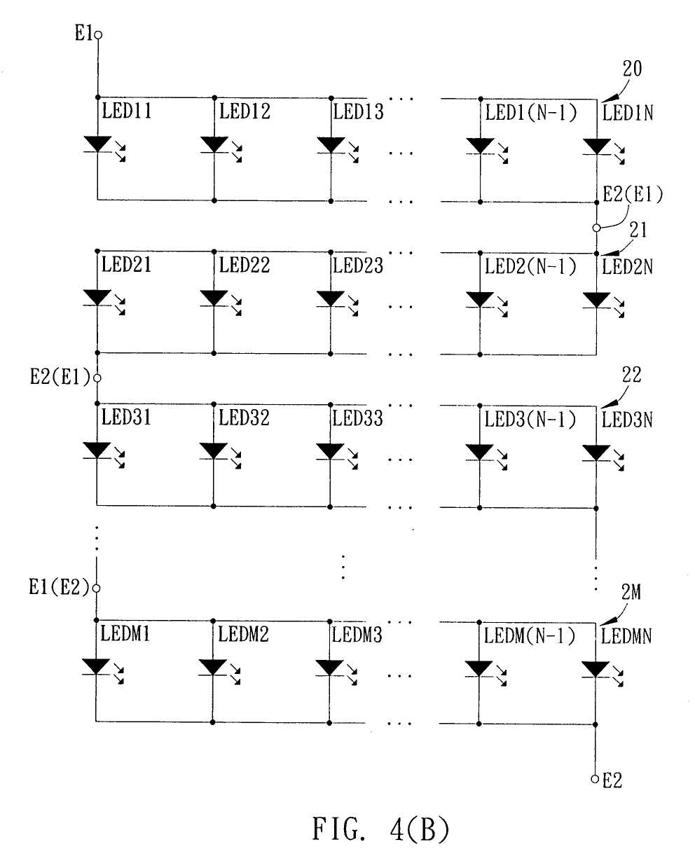

FIG. 4A is a schematic view showing the first preferred embodiment of a resistance balance circuit of the present invention. FIG. 4B is a schematic view showing the second preferred embodiment of a resistance balance circuit formed with a plurality of series-connected light emitting diode array structures shown in FIG. 4A. The resistance balance circuit is applicable to at least two electronic components aligned in a row matrix so as to achieve circuit resistance balance in the routes for current passing the electronic components in the row matrix structure. Advantages are namely homogeneity of current passing the electronic components in every route, cost reduction, and process streamlining. The electronic components of the following preferred embodiments are exemplified by light emitting diodes. A point to note is that, in practice, any electronic components that require current homogeneity can be used in the implementation of the present invention as appropriate.

Referring to FIG. 4A again, the resistance balance circuit comprises a plurality of light emitting diodes (LED 11, LED 12, . . . , LED 1N), an input end E1, and an output end E2. The light emitting diodes (LED 11, LED 12, . . . , LED 1N) are aligned in a row matrix and connected to one another in parallel so as to form a row matrix structure 2. In this preferred embodiment, routes (P11, P12, . . . , P1N, P21, P22, . . . , P2N) connecting the light emitting diodes (LED 11, LED 12, . . . , LED 1N) to one another in parallel are equal in length. Route S1 connects the input end E1 and one end of the row matrix structure 2. Current enters the input end E1 and passes the light emitting diodes (LED 11, LED 12, . . . , LED 1N) in the row matrix structure 2. The output end E2 is connected to one end of the row matrix structure 2 via another route S2. The input end E1 and output end E2 are disposed at opposite corners of the row matrix structure 2. Current passing the light emitting diodes (LED 11, LED 12, . . . , LED 1N) exits the row matrix structure 2 by the output end E2.

With current entering the input end E1 of the row matrix structure 2 of the resistance balance circuit, the current passes the light emitting diode LED 11 via route S1, route P21, route P22, . . . , route P2N, and route S2, the light emitting diode LED 12 via route S1, route P11, route P22, . . . , route P2N, and route S2, the light emitting diode LED 13 via route S1, route P11, route P12, . . . , route P2N, and route S2, and the other light emitting diodes via routes inferable by analogy. Circuit resistance balance can be achieved by allowing current to pass the light emitting diodes (LED 11, LED 12, . . . , LED 1N) via the same routes, for two reasons: first, the routes (P11, P12, . . . , P1N, P21, P22, . . . , P2N) connecting the light emitting diodes (LED 11, LED 12, LED 1N) in parallel are of equal length; second, current passing the light emitting diodes (LED 11, LED 12, . . . , LED 1N) has to pass the current input route S1 and the current output route S2.

A point to note is that FIG. 4A illustrates merely one of the preferred embodiments of the resistance balance circuit of the present invention and is not intended to limit the present invention. To be specific, the routes (P11, P12, . . . , P1N, P21, P22, . . . , P2N) connecting the light emitting diodes (LED 11, LED 12, . . . , LED 1N) to one another in parallel are not necessarily of equal length; however, a feature essential to the resistance balance circuit of the present invention is that the routes for current passing the light emitting diodes (LED 11, LED 12, . . . , LED 1N) are of equal length from the input end E1 to the output end E2. On the other hand, the resistance balance circuit of the present invention can work without the route S1 for electrical connection of the input end E1 and the row matrix structure 2, and the route S2 for electrical connection of the output end E2 and the row matrix structure 2, provided that the input end E1 and the output end E2 are directly formed in the row matrix structure 2.

Referring to FIG. 4B, a plurality of row matrix structures of a resistance balance circuit shown in FIG. 4A are connected to one another in series. The output end and input end of a row matrix structure of one level are electrically connected to the input end of the row matrix structure of the lower level and the output end of the row matrix structure of the upper level respectively, such that the plurality of row matrix structures are connected to one another in series.

With the row matrix structures (20, 21, 22, . . . , 2M) of a resistance balance circuit being connected to one another in series, the area for aligning the light emitting diodes increases. The light emitting diodes of a single row matrix structure (20, 21, 22, . . . , 2M) are connected to one another in parallel. As regards the row matrix structures (20, 21, 22, . . . , 2M), the routes for current passing the light emitting diodes (LED 11, LED 12, . . . , LED 1N; LED 21, LED 22, . . . , LED 2N; LED 31, LED 32, . . . , LED 3N; and LED M1, LED M2, . . . , LED MN) from the input end E1 to the output end E2 are equal in length, and thus the same current passes each of the light emitting diodes. Since the row matrix structures (20, 21, 22, . . . , 2M) of the resistance balance circuit are connected to one another in series, the same current exits by the output ends E2 connected to the row matrix structures (20, 21, 22, 2M).

The resistance balance circuit can be fabricated by either a semiconductor packaging technique or a combination of the semiconductor packaging technique and a circuit board printing technique. For instance, as taught by a preferred embodiment for the process of fabricating the resistance balance circuit, the row matrix structure comprising the parallel-connected light emitting diodes is a semiconductor package, wherein the input end and output end are pins provided by the semiconductor package. Moreover, as taught by another preferred embodiment for the process of fabricating the resistance balance circuit, the light emitting diodes are each a semiconductor package, wherein the route for connecting the light emitting diodes to one another in parallel, the route for electrically connecting the input end to the row matrix structures, and the route for electrically connecting the output end to the row matrix structures are fabricated by a circuit board printing technique. A fabrication process technique is adopted, depending on the related preferred embodiment.

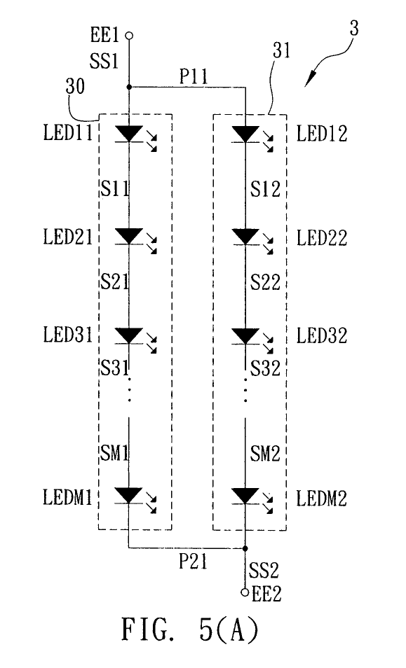

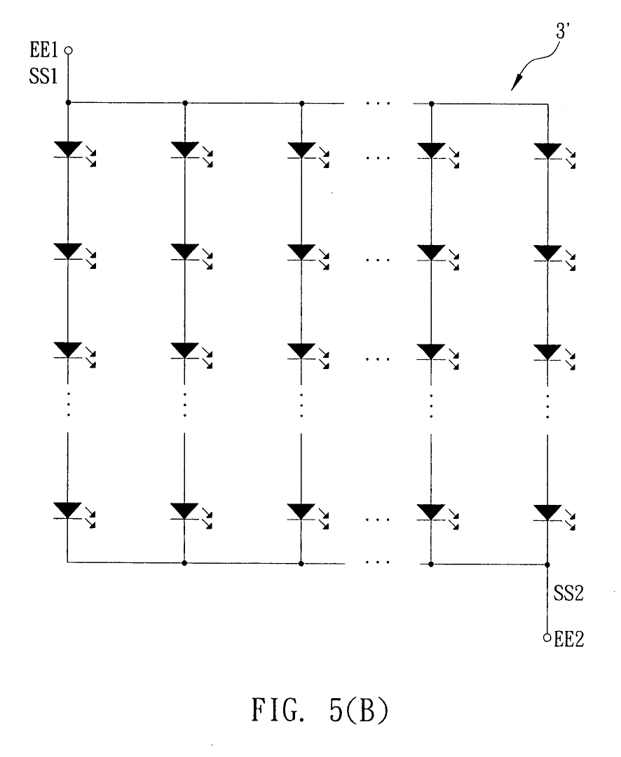

Referring to FIG. 5A, which is a schematic view showing the third preferred embodiment of the resistance balance circuit of the present invention, the resistance balance circuit comprises the first level column matrix structure 30, second level column matrix structure 31, input end EE1, and output end EE2. The first level column matrix structure 30 comprises a plurality of light emitting diodes (LED 11, LED 21, LED 31, . . . , LED M1) connected to one another in series. The second level column matrix structure 31 comprises a plurality of light emitting diodes (LED 12, LED 22, LED 32, . . . , LED M2) connected to one another in series. The second level column matrix structure 31 is connected to the first level column matrix structure 30 in parallel, thus forming a multi-level column matrix structure 3. The second level column matrix structure 31 comprises as many series-connected light emitting diodes as the first level column matrix structure 30.

The input end EE1 is disposed at one end of the multi-level column matrix structure 3. Current enters the input end EE1 and passes the light emitting diodes (LED 11, LED 21, LED 31, . . . , LED M1; and LED 12, LED 22, LED 32, . . . , LED M2) in the multi-level column matrix structure 3. The output end EE2 and the input end EE1 are disposed at opposite corners of the multi-level column matrix structure 3 and configured for exit and entry of current passing the light emitting diodes (LED 11, LED 21, LED 31, . . . , LED M1; and LED 12, LED 22, LIED 32, . . . , LED M2) in the multi-level column matrix structure 3. The routes for current passing the light emitting diodes (LED 11, LED 21, LED 31, . . . , LED M1; and LED 12, LED 22, LED 32, . . . , LED M2) from the input end EE1 to the output end EE2 are equal in length.

Refer to FIG. 5A. The first level column matrix structure 30 is connected to the second level column matrix structure 31 in parallel. The light emitting diodes in the first level column matrix structure 30 are connected to one another in series. The light emitting diodes in the second level column matrix structure 31 are connected to one another in series. Routes (S11, S21, S31, . . . , SM1; and S12, S22, S32, SM2) for connecting the light emitting diodes (LED 11, LED 21, LED 31, LED M1; and LED 12, LED 22, LED 32, . . . , LED M2) to one another in series and the routes (P11 and P21) for connecting the first level column matrix structure 30 to the second level column matrix structure 31 in parallel are equal in length. With the current that takes route SS1, enters the input end EE1, and passes a plurality of series-connected light emitting diodes (LED 11, LED 21, LED 31, . . . , LED M1) of the first level column matrix structure 30 and a plurality of series-connected light emitting diodes (LED 12, LED 22, LED 32, . . . , LED M2) of the second level column matrix structure 31 being the same, the number of series-connected light emitting diodes of the second level column matrix structure 31 and the number of series-connected light emitting diodes of the first level column matrix structure 30 being the same, and the length of routes being the same, the same current passes the first level column matrix structure 30 and the second level column matrix structure 31. Hence, the resistance balance circuit of this preferred embodiment is conducive to resistance balance of current passing the light emitting diodes (LED 11, LED 21, . . . , LED M1; and LED 12, LED 22, . . . , LED M2).

A point to note is that FIG. 5A illustrates merely one of the preferred embodiments of the resistance balance circuit of the present invention and is not intended to limit the present invention. To be specific, the routes (S11, S21, S31, . . . , SM1; and S12, S22, S32, . . . , SM2) connecting the light emitting diodes (LED 11, LED 21, LED 31, . . . , LED M1; and LED 12, LED 22, LED 32, . . . , LED M2) to one another in series are not necessarily of equal length, nor are the routes (P11 and P21) connecting the first level column matrix structure 30 to the second level column matrix structure 31 in parallel. What is important to the resistance balance circuit of the present invention is that the routes for current passing the light emitting diodes (LED 11, LED 21, LED 31, . . . , LED M1; and LED 12, LED 22, LED 32, . . . , LED M2) from the input end EE1 to the output end EE2 are of the same length. Also, the resistance balance circuit of the present invention can dispense with the route SS1 for electrical connection of the input end EE1 and the multi-level column matrix structure 3, and the route SS2 for electrical connection of the output end EE2 and the multi-level column matrix structure 3, provided that the input end EE1 and the output end EE2 are directly formed in the multi-level column matrix structure 3.

Referring to FIG. 5B, which is a schematic view showing the fourth preferred embodiment of a resistance balance circuit of the present invention, a plurality of first level column matrix structures and second level column matrix structures shown in FIG. 5A are parallel-connected between the first level column matrix structure 30 and the second level column matrix structure 31, so as to form a multi-level column matrix structure 3′ of an even greater area and increase the area for aligning light emitting diodes. The route for the plurality of parallel-connected column matrix structures shares the same features with the aforesaid first level column matrix structure 30 and second level column matrix structure 31 and therefore is not reiterated herein for the sake brevity. However, a point to note is that the output end EE1 and input end EE2 of the resistance balance circuit of the fourth preferred embodiment are also disposed at opposite corners of the multi-level column matrix structure 3′, wherein current enters the input end EE1, passes the light emitting diodes in the column matrix structures of all levels, and exits the light emitting diodes in the column matrix structures of all levels through the output end EE2.

The resistance balance circuit of the fourth preferred embodiment can be fabricated by either a semiconductor packaging technique or a combination of the semiconductor packaging technique and a circuit board printing technique. For instance, as taught by a preferred embodiment for the process of fabricating the resistance balance circuit, the column matrix structures are implemented as a semiconductor package, wherein the input end and output end are pins provided by the semiconductor package. Moreover, as taught by another preferred embodiment for the process of fabricating the resistance balance circuit, the light emitting diodes of the multi-level column matrix structure are each a semiconductor package, wherein the routes for connecting the light emitting diodes to one another in series, connecting the column matrix structures of all levels to one another in parallel, connecting the input end to the multi-level column matrix structure electrically, and connecting the output end to the multi-level column matrix structure electrically are fabricated by a circuit board printing technique. A fabrication process technique is adopted, depending on the related preferred embodiment.

A resistance balance circuit of the present invention enhances homogeneity of current passing electronic components, wherein at least two electronic components aligned in a column matrix or a row matrix are electrically connected to one another. The prior art is faced with a problem, that is, lack of homogeneity in luminance of an array of light emitting diodes that collectively function as a lighting device. The resistance balance circuit of the present invention solves the problem by achieving resistance balance of routes for current passing light emitting diodes despite an increase in the area for aligning the light emitting diodes. Also, the process for fabricating the resistance balance circuit of the present invention is cheaper and simpler than that for fabricating a conventional array of light emitting diodes.

The aforesaid embodiments merely serve as the preferred embodiments of the present invention. The aforesaid embodiments should not be construed as to limit the scope of the present invention in any way. Hence, many other changes can actually be made in the present invention. It will be apparent to those skilled in the art that all equivalent modifications or changes made to the present invention, without departing from the spirit and the technical concepts disclosed by the present invention, should fall within the scope of the appended claims.

What is claimed is:

1. A resistance balance circuit, comprising:
at least two electronic components aligned in a row matrix, connected to one another in parallel, thereby forming a row matrix structure;
an input end disposed at one end of said row matrix structure and configured for entry of current passing said electronic components in said row matrix structure; and
an output end disposed diagonally opposite to said output end in said row matrix structure and configured for exit of said current passing said electronic components in said row matrix structure, wherein routes for said current passing said electronic components from said input end to said output end are equal in length.

2. The resistance balance circuit of claim 1 being a semiconductor package, wherein said input end and output end are pins provided by said semiconductor package.

3. The resistance balance circuit of claim 1, further comprising a plurality of said row matrix structures, said row matrix structures being semiconductor packages, wherein said output end and input end of said row matrix structures of one level are electrically connected to said input end of said row matrix structures of the lower level and said output end of said row matrix structures of the upper level respectively, and said routes for said current passing said electronic components in said row matrix structures of all levels from said input end to said output end of said row matrix structures of all levels are equal in length.

4. The resistance balance circuit of claim 1, wherein said electronic components are each a semiconductor package, and routes connecting said electronic components to one another in parallel, connecting said input end to said row matrix structure electrically, and connecting said output end to said row matrix structure electrically are fabricated by a circuit board printing technique.

5. The resistance balance circuit of claims 1, further comprising a plurality of said row matrix structures, wherein said output end and input end of said row matrix structures of one level are electrically connected to said input end of said row matrix structures of the lower level and said output end of said row matrix structures of the upper level respectively, and said routes for said current passing said electronic components in said row matrix structures of all levels from said input end to said output end of said row matrix structures of all levels are equal in length.

6. The resistance balance circuit of claim 5, wherein said electronic components are light emitting diodes.

7. The resistance balance circuit of claims 1, wherein said electronic components are light emitting diodes.

8. A resistance balance circuit, comprising:
a first level column matrix structure comprising at least two electronic components connected to one another in series;
a second level column matrix structure comprising at least two electronic components connected to one another in series, wherein said second level column matrix structure is connected to said first level column matrix structure in parallel, and said first level column matrix structure comprises as many series-connected electronic components as said second level column matrix structure, thereby forming a multi-level column matrix structure;
an input end disposed at one end of said multi-level column matrix structure and configured for entry of current passing said electronic components in said multi-level column matrix structure; and
an output end disposed diagonally opposite to said output end in said multi-level column matrix structure and configured for exit of said current passing said electronic components in said multi-level column matrix structure, wherein routes for said current passing said electronic components from said input end to said output end are equal in length.

9. The resistance balance circuit of claim 8 being a semiconductor package, wherein said input end and output end are pins provided by said semiconductor package.

10. The resistance balance circuit of claim 9, wherein at least one third level column matrix structure is parallel-connected to between said first level column matrix structure and said second level column matrix structure and provided with at least two series-connected electronic components, and said routes for said current passing said electronic components in said column matrix structures of all levels from said input end to said output end are equal in length.

11. The resistance balance circuit of claim 8, wherein said first level column matrix structure and said second level column matrix structure are semiconductor packages, and said routes connecting said first level column matrix structure to said second level column matrix structure in parallel, connecting said input end to said multi-level column matrix structure electrically, and connecting said output end to said multi-level column matrix structure electrically are fabricated by a circuit board printing technique.

12. The resistance balance circuit of claims 8, wherein at least one third level column matrix structure is parallel-connected to said first level column matrix structure and said second level column matrix structure and provided with at least two series-connected electronic components, and said routes for said current passing said electronic components in said column matrix structures of all levels from said input end to said output end are equal in length.

13. The resistance balance circuit of claim 12, wherein said electronic components in said third level column matrix structure are semiconductor packages and said routes connecting said electronic components to one another in series and connecting said third level column matrix structure, said first level column matrix structure, and said second level column matrix structure in parallel are fabricated by a circuit board printing technique.

14. The resistance balance circuit of claim 8, wherein said electronic components in said first level column matrix structure and said second level column matrix structure are semiconductor packages, and said routes connecting said electronic components to one another in series, connecting said second level column matrix structure to said first level column matrix structure in parallel, connecting said input end to said multi-level column matrix structure electrically, and connecting said output end to said multi-level column matrix structure electrically are fabricated by a circuit board printing technique.

15. The resistance balance circuit of claims 8, wherein at least one third level column matrix structure is parallel-connected to said first level column matrix structure and said second level column matrix structure and provided with at least two series-connected electronic components, and said routes for said current passing said electronic components in said column matrix structures of all levels from said input end to said output end are equal in length.

16. The resistance balance circuit of claim 15, wherein said electronic components in said third level column matrix structure are semiconductor packages, and said routes connecting said electronic components to one another in series and connecting said third level column matrix structure, said first level column matrix structure, and said second level column matrix structure in parallel are fabricated by a circuit board printing technique.

17. The resistance balance circuit of claims 8, wherein said electronic components are light emitting diodes.
